(19) United States
(12) Patent Application Publication
(10) Pub. No.: US 2019/0041833 A1
(43) Pub. Date: Feb. 7, 2019

(54) PRODUCTION PLANT WITH CONTROL OF THE PRODUCTION AND/OR CONSUMPTION RATE

(71) Applicant: Robert Bosch GmbH, Stuttgart (DE)

(72) Inventors: Michael Walther, Renningen (DE); Christian Kircher, Stuttgart (DE); Josef Kleckner, Leonberg (DE); Marcus Hlavac, Stuttgart-Untertuerkheim (DE); Martin Schoepf, Stuttgart (DE); Martin Dieterle, Ludwigsburg (DE); Wolfgang Arnold, Heimsheim (DE)

(21) Appl. No.: 16/074,488

(22) PCT Filed: Dec. 14, 2016
(86) PCT No.: PCT/EP2016/080913

§ 371 Date: Aug. 1, 2018

(30) Foreign Application Priority Data
Feb. 1, 2016 (DE) 10 2016 201 460.9

(51) Int. Cl. G05B 19/418

(52) U.S. Cl. CPC G05B 19/41865; G05B 2219/45145; G05B 2219/49067; G05B 2219/32187; G05B 2219/43124; G05B 2219/32018

(57) ABSTRACT

Production plant (1) for producing at least one end product (3) from at least one primary starting material (2), comprising at least one processing station (41-43) which processes at least one starting material (21-23) to form at least one product (31, 32, 33), and a process controller (51-53) which can control at least one variable (71-73), which is a measure of a quality feature of the product (31-33) and/or is correlated with a quality feature of the product (31-33), by influencing at least one manipulated variable (61-63) acting on the processing station (41-43), wherein the process controller (51-53) is additionally designed to control the production rate (31a-33a) of the processing station (41-43) for the product (31-33) and/or the consumption rate (21a-23a) of the processing station (41-43) with regard to starting material (21-23) by acting on the manipulated variable (61-63).

### BACKGROUND OF THE INVENTION

The present invention relates to production plants with one or more processing stations for producing an end product from at least one primary starting material.

Industrial production processes are often carried out in a controlled manner. A processing station at which a starting material is processed to form a product includes a process controller, which acts on the processing station by way of one or more manipulated variables and receives as feedback at least one variable to be controlled. If this variable is, for example, a measure of a quality feature of the product, and/or if this variable is correlated with a quality feature of the product, this quality feature can be kept at a constant level even when disturbing influences act on the production process. The disturbing influences are compensated by the manipulated variable being correspondingly corrected by the process controller.

Such production processes and associated process controllers are known for example from EP 1 867 422 A2.

### SUMMARY OF THE INVENTION

Within the scope of the invention, a production plant for the production of at least one end product from at least one primary starting material has been developed. This production plant comprises at least one processing station, which processes at least one starting material to form at least one product. Also provided is a process controller, which can control at least one variable which is a measure of a quality feature of the product, and/or which is correlated with a quality feature of the product, by influencing at least one manipulated variable acting on the processing station.

The term starting material comprises all materials, media, articles and other resources that are required by the processing station for the production of the product, in particular resources that are consumed in the process. These include for example raw materials, energy, auxiliaries, consumables and preliminary products produced by other processing stations. Tools and other parts of the processing station that are subject to wear, and consequently are likewise consumed sooner or later, are also considered to be included among the starting materials.

The term product comprises generally the result of work performed by the processing station. A product may in particular be for example an improved or processed raw material, a preliminary product or semifinished product for further processing by further processing stations or an article to be produced by the production plant as a whole.

The production plant may comprise a series or parallel arrangement of processing stations or any desired mixed forms thereof. A series arrangement of two processing stations means that a product of the first processing station is used by the second processing station as a starting material. A parallel arrangement of two processing stations means that the two processing stations receive the same or similar starting materials and produce the same or similar products from them, in particular products that are interchangeable with one another.

Primary starting materials are those starting materials that are supplied altogether to the production plant considered as a whole. End products are those products that result from the overall activity of the production plant considered as a whole.

In the context of this invention, the term controlling a variable comprises in particular controlling the variable to a preselected setpoint value or setpoint profile, but also for example keeping the variable constant at the current value, without this value being specifically preselected. Generally, the term controlling comprises acting on a manipulated variable in order to minimize the deviation of an actual state, defined by a functional of the controlled variable, from a desired state.

A variable correlated with a quality feature of the product is understood in particular as meaning a variable of which the value or profile is causal for the presence or absence of the quality feature. It may therefore be, for example, a process variable which acts on the quality of the product or is in some other way of significance for the quality of the product.

According to the invention, the process controller is additionally designed to control the production rate for the product of the processing station, and/or the consumption rate of the starting material of the processing station, by acting on the manipulated variable. The production rate may be defined in particular as the quantity per unit of time of the product provided by the processing station. The consumption rate may be defined in particular as the consumption of starting material per unit of time by the processing station.

It has been realized that the cost-effectiveness of production can surprisingly be improved by this measure. Until now, quantitative production controls were used primarily in the area of logistics and assembly, while they were not considered in actual production, and in particular in production technology. Instead, fixed production capacities, and the processing processes provided for them, were optimally utilized in themselves, with fixed creation times and specified quality features.

Such optimum utilization is often equivalent to the cost-effective optimum, but by no means not always. For example, on a machining production machine the production costs per product produced may depend on the degree of utilization of the machine, because, in the case of full utilization or even overloading of the machine, the energy consumption and/or the tool wear increase disproportionately. If a large number of products, for example diesel injectors, are required immediately because there is otherwise an impending standstill elsewhere, for example in engine production, it may be economically advisable to operate the production machine to the limit, without regard for the increased costs per item. If, on the other hand, a smaller number is required, because further processing is stagnant or there is less acute demand for other reasons, that working point for utilization with the lowest costs per item may be advisable.

Alternatively or else in combination with the production rate, the consumption rate of the processing station may also be controlled. With such control it is possible, for example, to respond to a shortage of resources. For example, a semifinished product that is required by a number of processing stations and the available quantity of which does not meet the demand of all the processing stations may be distributed quantitatively among the processing stations such that the greatest possible value creation can still be achieved with the total quantity available.

The production rate and the consumption rate are quite obvious parameters that can be set by the process operator with regard to the operational requirements. Controlling the variable that is a measure of a quality feature of the product, and/or is correlated with a quality feature of the product, may be equated here with controlling the production rate and/or consumption rate. Particularly preferably, however, the control is prioritized with regard to product quality. In particular, for example, interventions in the manipulated variable for the purpose of changing the production rate or consumption rate may only be allowed as a boundary condition to the extent that product quality does not as a result go below a preselected threshold value at any time.

The production rate and the consumption rate may be variables which exist or can be sampled with a comparatively slow time constant. If, for example, the product and/or the starting material take the form of discrete items, the time that is required for the production or for the consumption of an item limits the time constant. However, it expressly does not limit the time constant with which the variable that is a measure of a quality feature of the product, and/or which is correlated with a quality feature of the product, is sampled. This variable does not have to only come into existence when a discrete item of the product has been produced, but may for example also be a process variable and exist with a high temporal resolution during the production of the product that is about to be processed. Therefore, as before, the process controller can react directly and immediately to disturbances occurring during this production, and correspondingly correct the manipulated variable, with cycle times down to the range of milliseconds.

For the purpose of the setpoint-actual comparison, those variables that are taken as a basis for the control by the process controller are advantageously fed back into the process controller, so that there is a closed control loop.

The process controller advantageously receives at least one process variable from the processing station as additional feedback. This feedback may serve for example for monitoring boundary conditions, such as for instance loading limits of components of the processing station. It may however also be used, for example, for additionally designing the process controller to control this process variable. For example, the process controller may convert the requirement to control the production rate and/or consumption rate to a preselected value internally into preselections for one or more process variables. The desired production rate and/or consumption rate is then physically realized by corresponding control of the process variables to the new preselections. For example, the preselection for the production rate and/or consumption rate may be converted in machining production into a preselection for the machining force. The other machining parameters can then be adapted automatically in the course of the control to the new machining force such that products of consistent quality are produced. Alternatively or in combination with this, the additionally fed back process variable may for its part serve as a measure of a quality feature of the product, and/or it may be correlated with a quality feature of the product.

An example of this is a particularly advantageous refinement of the invention in which the processing station is designed to process a starting material to form a product by drilling. The process controller may then, for example, be designed to control the advancing force F of the drill as a process variable. For this purpose, the process controller may, for example, vary the rotational speed of the drill. In corresponding experiments conducted by the inventors, it has been possible in this way to prolong the lifetime of the drill by up to 30%.

By analogy, in a further particularly advantageous refinement of the invention, the processing station may be designed to process a starting material to form a product by milling. The process controller may then, for example, be designed to control the advancing rate v of the milling cutter as a process variable.

The process controller may also receive as an additionally fed back process variable a measured variable R, which describes the chattering of the milling cutter. The chattering of a milling cutter comprises vibrations that occur increasingly at greater processing speeds, and for example reduce both the lifetime of the milling cutter and the processing accuracy. So if, with the quality requirement remaining the same, the preselection of a highest possible production rate is made, the process controller can respond to this for example by carrying out at least the initial rough part of the workpiece machining at the maximum speed, and with great chattering, and significantly reduce the speed for the finishing off of filigree structures, in order to minimize the chattering in the interests of high surface quality.

The process controller may be a unit that is independent of the actual open-loop control of the processing station and also does not have to be integrated in the processing station. It is therefore possible, for example, that a multiplicity of processing stations are coupled to a central process controller by way of a communication connection. Similarly, a process controller in the form of a separate system box may be retrofitted on a processing station which was previously only run under open-loop control and not closed-loop control.

Conversely, however, it is also possible to integrate the process controller in the open-loop control of the processing station from the outset.

The open-loop control of the processing station may be, for example, a CNC controller, a programmable controller or else a speed controller for a frequency converter. The process variable from the processing station that the process controller receives as additional feedback may be, for example, an item of state information from the open-loop control of the processing station. The process variable may however also be, for example, a measured value that is measured by a sensor.

In a particularly advantageous refinement of the invention, at least two processing stations are provided, at least one product of the first processing station being a starting material of the second processing station. The consumption rate of preliminary products of the second processing station and the production rate of these preliminary products of the first processing station may then, for example, be coordinated with one another such that there is neither a backlog of unprocessed preliminary products between the first processing station and the second processing station nor a standstill of the second processing station because of an acute shortage of preliminary products. Similarly, for example, a number of processing stations may be fed preliminary products from one and the same upstream processing station. Conversely, for example, a number of processing stations that produce the same or similar preliminary products may supply to a downstream processing station that requires these preliminary products as starting materials.

In a further particularly advantageous refinement of the invention, a first process controller is provided, which receives at least one process variable in each case from each processing station as feedback and influences a manipulated variable acting on the first processing station. A second process controller is also provided, which receives at least one process variable from the second processing station and also at least one variable which is a measure of a quality feature of the product, and/or which is correlated with a quality feature of the product, as feedback and influences a manipulated variable acting on the second processing station. The first process controller may then, for example, serve primarily for converting the preselection with respect to the production rate and/or consumption rate. The second process controller may, for example, serve primarily for ensuring consistent quality of the end product.

In a further particularly advantageous refinement of the invention, a production controller is provided, which is designed to control the consumption rate of at least one primary starting material of the production plant, and/or the production rate for the end product of the production plant, by acting on the setpoint values of the process controllers for the production rates for the respective products of the processing stations, and/or for the consumption rates of the respective starting materials of the processing stations.

The consumption rate and the production rate of the production plant as a whole are the variables that are ultimately of interest from an economic viewpoint. By operating the process controllers once again with preselections for consumption rates and/or production rates at the level of the individual processing stations, there is no logical break between the two levels. In this way, even a complex network of base stations arranged partly in series, partly in parallel with one another remains feasible.

Furthermore, the production controller can respond particularly easily to specifically the two disturbances that occur most frequently in such a complex integrated system, that is to say failures of processing stations on the one hand and shortages of resources on the other hand. For example, the failure of a processing station can be compensated by increasing the utilization of other processing stations that produce the same product. Conversely, when there is a shortage of certain starting materials, processing stations can be operated at a low level, in order to be able to use the scarce starting materials at other processing stations where they are needed more urgently. The production controller therefore orchestrates the interaction of the individual processing stations appropriately for the situation, so that the value creation and the consumption of resources necessary for it are kept in an optimum relationship.

The production controller may, for example, transmit the preselections with respect to the consumption and/or production rate to the individual processing stations in the form of a scaling factor normalized to the respective maximum production capacity, a value of 0 standing for a standstill and a value of 1 standing for full utilization. The production controller may, for example, receive the preselections with respect to the production rate of end products and/or with respect to the consumption of primary starting materials from a control system, such as for instance SAP, or a production management system (Manufacturing Execution System, MES) and for its part report the actual state of the production rate and/or consumption rate back to the control system.

It is not absolutely necessary that between the production controller and the process controllers responsible for the individual processing stations there is in each case a closed control loop with feedback. For controlling the consumption rate and/or the production rate of the production plant as a whole, the production controller only has to know the actual state of this consumption rate and/or production rate. This controlled quality can be improved, however, by the process controller transmitting aggregated information concerning the actual state of the processing station to the production controller. If, for example, a processing station has failed, there is no need for any attempt by the production controller to increase the utilization of this processing station.

The process controller and the production controller may be respectively designed as independent units, which can be sold separately and retrofitted on an existing processing station, or in an existing production plant. After what has been said above, the invention therefore also relates to a process controller that is additionally designed to control the production rate and/or the consumption rate of the base station by acting on the processing station in a way that is dictated by a manipulated variable. Similarly, the invention also relates to a production controller for a production plant made up of a number of processing stations that is designed to control the production rate and/or the consumption rate of the production plant by acting on the setpoint values of the process controllers for the production rates, and/or for the consumption rates, of the base stations.

The invention has at least the following major advantages over the prior art:

The adaptation of the manipulated variables and process parameters of the individual processing stations is no longer an independent manual procedure. The manipulated variables and process parameters are optimally set and maintained by the process controller both for any tool state and for any individual tool and workpiece pairing.

The relevant quality features of the end products can be achieved with process parameters that are variable within meaningful limits. As a consequence, the process stability of the individual processing steps is ensured.

The production controller has a direct influence on the manipulated variables of the individual processing stations, and consequently also on the production tempo and on the costs per item.

Along with an aim of optimizing production control purely from an economic aspect, extensive linkages within the value creation chain are possible. It is similarly possible to respond quickly to machine failures or unplanned shortages of resources.

### BRIEF DESCRIPTION OF THE DRAWINGS

Further measures that improve the invention are presented more specifically below together with the description of the preferred exemplary embodiments of the invention on the basis of figures.

In the figures:

FIG. 1 shows an exemplary embodiment of a production plant 1 according to the invention with a processing station 41;

FIG. 2 shows an exemplary embodiment of a production plant 1 according to the invention with two cascaded processing stations 41 and 42.

FIG. 3 shows an exemplary embodiment of a production plant 1 according to the invention with a production controller 9.

### DETAILED DESCRIPTION

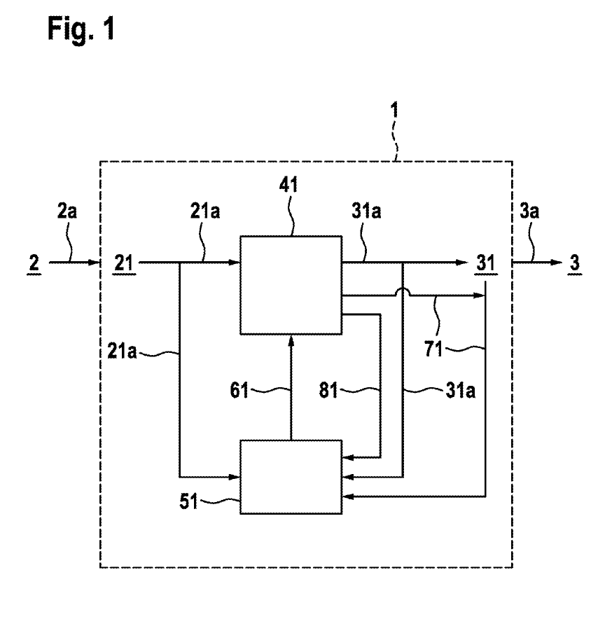

According to FIG. 1, the production plant 1 comprises a single processing station 41. The primary starting material 2, which is supplied to the production plant 1 as a whole and is consumed by the production plant 1 at a rate 2a, is at the same time the starting material 21 of the processing station 41. The processing station 41 consumes the starting material 21 at a rate 21a and processes the starting material 21 at a rate 31a to form a product 31. This product 31 is at the same time the end product 3 of the production plant 1. The production rate 3a of the production plant 1 as a whole is identical to the production rate 31a of the single processing station 41.

Along with the variable 71, which is a measure of a quality feature of the product 31, the process controller 51 assigned to the processing station 41 receives both the consumption rate 21a and the production rate 31a of the processing station 41. Consequently, the process controller 51 is capable of optionally controlling the consumption rate 21a, the production rate 31a or a combination of the consumption rate 21a and the production rate 31a with consistent quality of the product 31. For this purpose, the process controller 51 influences a manipulated variable 61 acting on the processing station 41. The variable 71 is not only registered on the finished product 31, but also at the same time taken, on a much faster timescale, directly from the process proceeding in the processing station 41.

In addition, the process controller 51 also receives a further process variable 81 from the processing station as further feedback, which may be used for monitoring boundary conditions.

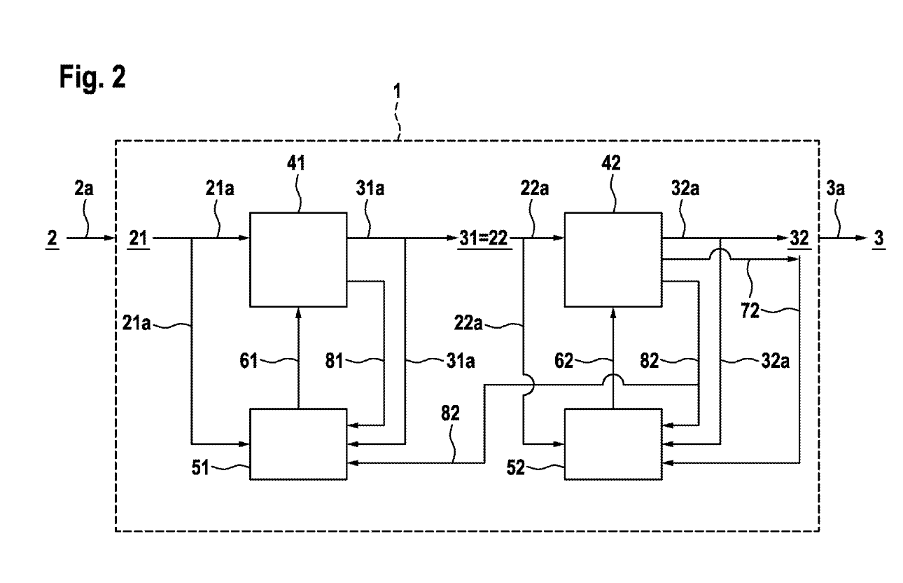

In the exemplary embodiment shown in FIG. 2, the production plant 1 comprises two processing stations 41 and 42 cascaded with one another. The primary starting material 2 is at the same time the starting material 21 of the first processing station 41, and the consumption rate 2a of primary starting material 2 is identical to the consumption rate 21a of the first processing station 41. The first processing station 41 produces a first product 31 at a rate 31a. This first product 31 is at the same time the starting material 22 of the second processing station 42, which produces the second product 32 from this starting material 22 at a rate 32a. In this case, the second product 32 is identical to the end product 3, which the production plant 1 as a whole produces, and the rate 3a, at which the end product 3 is produced, is identical to the production rate 32a of the second processing station 42. However, the consumption rate 22a of the second processing station 42 is not necessarily identical to the production rate 31a of the first processing station 41. Instead, the product 31 may be intermediately stored before it is supplied to the second processing station 42 as starting material 22.

The production plant 1 includes two process controllers 51 and 52. The first process controller 51 receives the consumption rate 21a and the production rate 31a of the first processing station 41 as feedback. In addition, the first process controller 51 receives a first process variable 81 from the first processing station 41 and a second process variable 82 from the second processing station 42. The first process controller 51 influences a manipulated variable 61, which acts on the first processing station 41. It undertakes the main work in the conversion of the quantitative preselections for production and resource consumption.

The second process controller 52 receives the consumption rate 22a and the production rate 32a of the processing station 42 as feedback. As further feedback, the second process controller 52 receives the variable 72, which is a measure of a quality feature of the product 32. The second process controller 52 consequently undertakes the final inspection of the product 32, which is at the same time the end product 3 of the production plant 1. By analogy with FIG. 1, the variable 72 is taken both from the finished product 32 and on a much faster timescale directly from the process proceeding in the processing station 42.

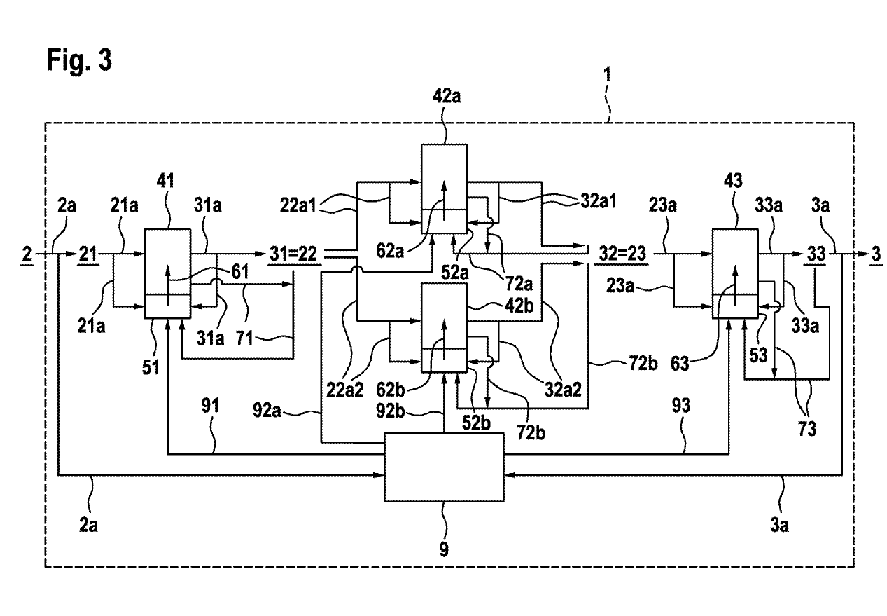

FIG. 3 shows a further exemplary embodiment of a production plant 1 according to the invention. In this exemplary embodiment, a mixed series and parallel arrangement of four processing stations 41, 42a, 42b and 43 is provided.

The first processing station 41 consumes a starting material 21, which is at the same time the primary starting material 2 of the production plant 1 as a whole, at a consumption rate 21a and produces a first product 31 from this starting material 21 at a production rate 31a. The process controller 51, which is assigned to the first processing station 41 and acts on the first processing station 41 by way of a manipulated variable 61, receives as feedback the consumption rate 21a and the production rate 31a of the first processing station 41, as well as also a manipulated variable 71, which is a measure of a quality feature of the first product 31. The process controller 51 is designed to control along with the variable 71 also the consumption rate 21a, and/or the production rate 31a, of the first processing station.

The first product 31 is an intermediate product, which is supplied as starting material 22 to two processing stations 42a and 42b arranged in parallel. The two processing stations 42a and 42b produce a second product 32 from the starting material 22. In this case, the consumption rate 22a1 of the starting material 22 of the processing station 42a may differ from the consumption rate 22a2 of the starting material 22 of the processing station 42b. Similarly, the production rate 32a1 for the second product 32 of the processing station 42a may differ from the production rate 32a2 for the second product 32 of the processing station 42b. The sum of the consumption rates 22a1 and 22a2 of the starting material 22 of the two processing stations 42a and 42b does not have to correspond at all times to the production rate 31a at which this starting product 22 is produced as the first product 31 by the processing station 41. Between the processing stations 41 on the one hand and also 42a and 42b on the other hand, there is a storage capacity, which receives excess production on the part of the processing station 41 and covers excess demand on the part of the processing stations 42a and 42b.

The process controller 52a assigned to the processing station 42a influences the processing station 42a as dictated by a manipulated variable 62a. It receives as feedback the consumption rate 22a1 and the production rate 32a1 of the processing station 42a, and also the variable 72a, which is a measure of a quality feature of the second product 32 produced by the processing station 42a.

By analogy, the process controller 52b assigned to the processing station 42b influences the processing station 42b as dictated by a manipulated variable 62b. It receives as feedback the consumption rate 22a2 and the production rate 32a2 of the processing station 42b, and also the variable 72b, which is a measure of a quality feature of the second product 32 produced by the processing station 42b.

The second product 32, produced by the two processing stations 42a and 42b, is at the same time the starting material 23 for the processing station 43. The processing station 43 consumes the starting material 23 at a consumption rate 23a and from it produces at the production rate 33a the third product 33, which is at the same time the end product 3 of the production plant 1 as a whole.

In this case there is once again storage capacity between the processing stations 42a and 42b on the one hand and the processing station 43 on the other hand, so that the consumption rate 23a of the processing station 43 does not have to correspond at all times to the sum of the production rates 32a1 and 32a2 of the processing stations 42a and 42b.

The process controller 53 assigned to the processing station 43 receives the consumption rate 23a and the production rate 33a of the processing station 43 and also a variable 73, which is a measure of a quality feature of the product 33, as feedback.

By analogy with FIGS. 1 and 2, the variables 71, 72a, 72b and 73 are not only determined on the basis of the finished products 31, 32 and 33, but also taken, on a much faster timescale, directly from the processes proceeding in the processing stations 41, 42a, 42b and 43.

Since only the processing station 41 consumes the starting material 21, which is identical to the primary starting material 2 of the production plant 1 as a whole, the consumption rate 21a of the first processing station 41 is identical to the consumption rate 2a of the production plant 1 as a whole.

Since only the processing station 43 produces the product 33, which is the end product 3 of the production plant 1 as a whole, the production rate 33a of the processing station 43 is identical to the production rate 3a of the production plant 1 as a whole.

The production controller 9 receives the consumption rate 2a and the production rate 3a of the production plant 1 as feedback. It is designed to control the consumption rate 2a, and/or the production rate 3a. For this purpose, the production controller 9 influences the setpoint values 91, 92a, 92b and 93 for the consumption rates 21a, 22a1, 22a2, 23a, and/or for the production rates 31a, 32a1, 32a2, 33a, of the processing stations 42, 42a, 42b and 43. In this case, the production controller may also receive further feedback concerning the state of the processing stations 42, 42a, 42b and 43, which for reasons of overall clarity are not depicted in FIG. 3.

The production controller 9 allows the production plant 1 as a whole to be operated between the extremes of the maximum production rate 3a and the minimum consumption rate 2a. It is also possible for example to respond to a failure of the processing station 42a by increasing the utilization of the processing station 42b correspondingly.

1. A production plant for the production of at least one end product from at least one primary starting material, the production plant comprising:
at least one processing station, which processes at least one starting material to form at least one product, and
a process controller, which controls at least one variable which is correlated with a quality feature of the product, by influencing at least one manipulated variable acting on the processing station,
wherein the process controller also controls the production rate for the product of the processing station, the consumption rate of starting material of the processing station, or both by acting on the at least one manipulated variable.

2. The production plant as claimed in claim 1, wherein the process controller receives at least one process variable from the processing station as additional feedback.

3. The production plant as claimed in claim 2, wherein the process controller controls the process variable.

4. The production plant as claimed in claim 1, wherein the processing station is configured to process a starting material to form a product by drilling.

5. The production plant as claimed in claim 3, wherein the process controller controls the advancing force F of the drill as a process variable.

6. The production plant as claimed in claim 1, wherein the processing station is designed to process a starting material to form a product by milling.

7. The production plant as claimed in claim 3, wherein the process controller is designed to control the advancing rate v of the milling cutter as a process variable.

8. The production plant as claimed in claim 2, wherein the process controller also receives as an additionally fed back process variable a measured variable R, which describes the chattering of the milling cutter.

9. The production plant as claimed in claim 1, wherein at least two processing stations are provided, at least one product of the first processing station being a starting material of the second processing station.

10. The production plant as claimed in claim 9, wherein a first process controller is provided, which receives at least one process variable in each case from each processing station as feedback and influences a manipulated variable acting on the first processing station, and in that a second process controller is also provided, which receives at least one process variable from the second processing station and also at least one variable which is a measure of a quality feature of the product, and/or which is correlated with a quality feature of the product, as feedback and influences a manipulated variable acting on the second processing station.

11. The production plant as claimed in claim 9, further comprising a production controller, configured to control the consumption rate of at least one primary starting material of the production plant, the production rate for the end product of the production plant or both, by acting on the setpoint values of the process controllers for the production rates for the respective products of the processing stations, the consumption rates of the respective starting materials of the processing stations, or both.

12. A process controller for a processing station in a production plant, which can control at least one variable, which is a measure of a quality feature of the product, and/or which is correlated with a quality feature of the product, by influencing at least one manipulated variable acting on the processing station, the processing station processing at least one starting material to form at least one product,
wherein
the process controller controls the production rate for the product (31, 32, 33) of the processing station, the consumption rate of starting material of the processing station, or both by acting on the manipulated variable.

13. A production controller for a production plant, which comprises at least two processing stations and also at least one process controller, at least one product of the first processing station being a starting material of the second processing station,
wherein
the production controller is designed to control the consumption rate of at least one primary starting material of the production plant, and/or the production rate for the end product of the production plant, by acting on the setpoint values of the process controllers for the production rates for the respective products of the processing stations, and/or for the consumption rates of the respective starting materials of the processing stations.
